(19) United States
(12) Patent Application Publication
(10) Pub. No.: US 2009/0007099 A1
(43) Pub. Date: Jan. 1, 2009

(54) MIGRATING A VIRTUAL MACHINE COUPLED TO A PHYSICAL DEVICE

(76) Inventors: Gregory D. Cummings, Portland, OR (US); Anil Vasudevan, Portland, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/769,629

(22) Filed: Jun. 27, 2007

(51) Int. Cl. G06F 9/455

(52) U.S. Cl. 718/1

(57) ABSTRACT

A virtual machine with a directly assigned network device and supported on a host may be migrated to other host without loss of network connectivity. Such migration is enabled by bonding a physical network interface driver (NIC) and a virtual NIC driver of the host. A virtual machine monitor of the host may determine whether the virtual machine is to be migrated to the other host. The virtual machine monitor may allow hot-plug removal of the network device. However, the virtual machine may still maintain network connectivity through the virtual NIC. The virtual machine may be migrated to the other host. After migration, the virtual machine may continue to maintain the network connectivity either through the virtual NIC driver or bond with a physical NIC driver of the network device coupled to the other host.

### BACKGROUND

A host system may support one or more virtual machines. A physical device may be coupled to a virtual machine of the host system. The virtual machine may need to be migrated to other host system.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing environment 100.

### DETAILED DESCRIPTION

The following description describes migrating a virtual machine coupled to a physical device. In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, and digital signals). Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

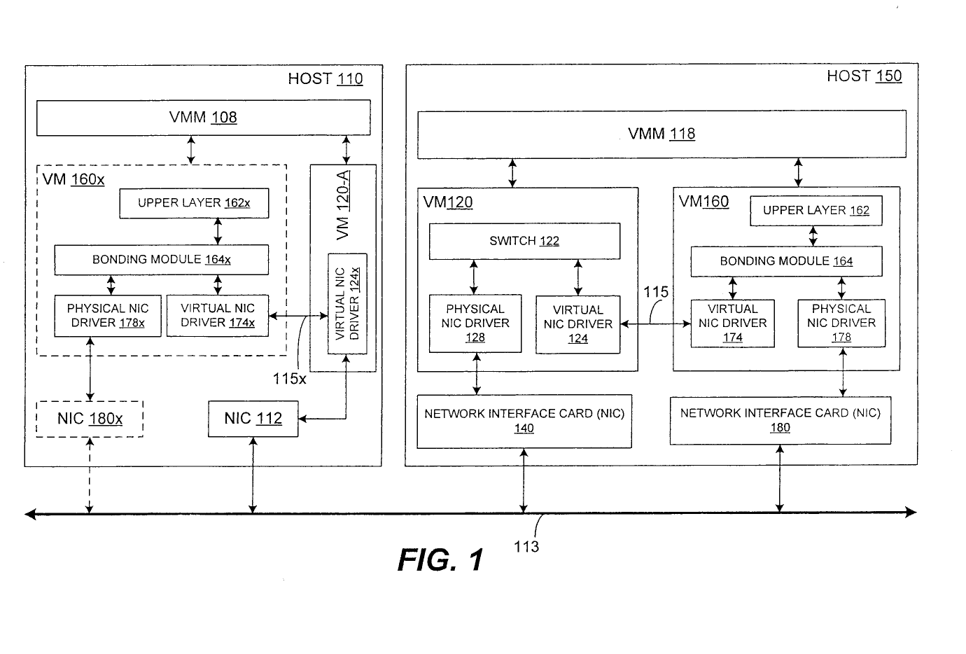

An embodiment of a computing environment 100 is illustrated in FIG. 1. The computing environment 100 may comprise a first host 110 and a second host 150. The second host 150 may comprise a virtual machine monitor 118, a first virtual machine VM120, a second virtual machine VM160, a first network interface card NIC140, and a second network interface card NIC180.

In one embodiment, VM120 may comprise a switch 122, a physical NIC driver 128, and a virtual NIC driver 124. In one embodiment, VM120 may be coupled to a network 113 through the NIC140. In one embodiment, VM120 may represent a specialized virtual machine that may provide network I/O services to other virtual machines such as the VM160.

In one embodiment, VM160 may comprise an upper layer 162, bonding module 164, and a virtual NIC driver 174. In one embodiment, the network packets generated by the upper layer 162 may be sent to the network 113 through the bonding module 164, physical NIC driver 178, and the NIC180. In one embodiment, the NIC180 may be referred to as being directly assigned to VM160.

As VM160 transfers packets to the NIC180 through the physical NIC driver 178, the physical NIC driver 178 may be referred to as a primary connector. In one embodiment, the path over which the packets may be transferred may be referred as a first direct connection. In one embodiment, VM160 may also be coupled to the network 113 through a first virtual connection. In one embodiment, a path of the first virtual connection may comprise the virtual NIC driver 174, the virtual NIC driver 124, the switch 122, physical NIC driver 128, and the NIC 140. In one embodiment, the virtual NIC driver 174 may be referred to as a secondary connector.

In one embodiment, VM160 may be migrated to the first host 110 in response to receiving a migration signal, which may indicate that VM160 is to be migrated. In one embodiment, a user of the host 150 or automated software supported by the host 150 may generate the migration signal. In one embodiment, the migration signal may be generated by the physical NIC driver 178 in response to detecting the failure of the NIC180. In one embodiment, the NIC180 may be hot-plug removed or decoupled from the second host 150.

In one embodiment, VMM118 may initiate migration of VM160 in response to receiving the migration signal. During migration, in one embodiment, VMM118 may send a change status signal to the bonding module 164. In one embodiment, the change status signal may indicate that the bonding module 164 may change the status of the virtual NIC driver 174 from secondary connector to primary connector. In one embodiment, VMM118 may determine whether the resources are available on the first host 110 to support VM160.

In one embodiment, to determine the availability of resources, VMM118 may send a resource enquiry signal to the first host 110. In one embodiment, the resource enquiry signal may comprise an estimate of the resources that may be used to support VM160 on the first host 110. In one embodiment, VMM118 may send a reservation request to the first host 110 to reserve a virtual machine (VM) container for VM160 in response to receiving a resource availability signal. In one embodiment, the resource availability signal may indicate the availability of the resources on the first host 110 to support VM160.

In one embodiment, VMM118 may send the reservation request in response to receiving a resource availability signal, which may indicate availability of the resources on the first host 110 to support VM160. In one embodiment, VMM118 may copy the VM pages from the second host 150 to the first host 110. In one embodiment, VMM118 may decouple VM160 from the NIC 180 and deactivate the physical NIC driver 178.

In one embodiment, the bonding module 164 may designate the virtual NIC driver 174 as the primary connector in response to receiving the change status signal. In one embodiment, the bonding module 164 may detect the deactivation of the physical NIC driver 178 and may decouple VM160 and VM120 by disconnecting the virtual bus 115.

In one embodiment, before the migration of VM160, the first host 110 may comprise a VMM108, a virtual machine 120-A, and a NIC 112. Before migration, the VM120-A may provide specialized network I/O services to other virtual machines, which may be supported by the first host 110. In one embodiment, the VM120-A may be coupled to the network 113 through the NIC 112. In one embodiment, the VM120-A may provide virtual network connectivity to the virtual machines supported by the first host 110.

During the migration, in one embodiment, the VMM108 of the first host 110 may check for the availability of resources to support VM160 in response to receiving the resource enquiry signal. In one embodiment, the VMM108 may send a resource availability signal to the second host 150 if the resources to support VM160 are available on the first host 110. In one embodiment, VMM108 may reserve a VM container in response to receiving the reservation request signal. In one embodiment, VMM108 may store the VM pages sent by VMM118.

In one embodiment, the migrated VM160 resident on the first host 110 may be referred to as a migrated virtual machine VM160x. In one embodiment, VMM108 may reattach the device drivers to VM160x. In one embodiment, VMM108 may advertise the network address of the VM160x. In one embodiment, VM160x may be deemed as activated on the first host 110. In one embodiment, activating VM160x on the host 110 may comprise storing the VM pages, reattaching the device drivers, establishing a virtual bus between VM160x and VM120x, and advertising the changed location.

In one embodiment, the bonding module 164x of VM160x may establish a virtual bus 115x between the virtual NIC driver 174x of VM160x and a virtual NIC driver of 124x of VM120-A. In one embodiment, the bonding module 164x may designate the virtual NIC driver 174x as the primary connector. As a result, the migrated virtual machine VM160x may be coupled to the network 113 through the specialized virtual machine VM120-A and the NIC 112. In one embodiment, a path comprising the virtual NIC driver 174x, the virtual NIC driver 124x, and the NIC112 may be referred to as a second virtual connection.

In one embodiment, the VM160x may detect the presence of the NIC180x coupled to the network 113 using the virtual network connectivity provided by the VM120-A. In one embodiment, the NIC180x may be hot-plugged to the first host 110. In response to detecting the presence of the NIC180x, in one embodiment, the bonding module 164x may designate the physical NIC driver 178x as the primary connector. In one embodiment, a path comprising the physical NIC driver 178x and NIC180x may be referred to as a second direct connection. In one embodiment, the bonding module 164x may change the status of the virtual NIC driver 174x to a secondary connector. In one embodiment, the VM160x may send network packets to the network 113 through the NIC180x. As a result, VM160x may be directly coupled to the network 113 through the NIC180x.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising:
determining whether a virtual machine coupled directly to a network is to be migrated, wherein the virtual machine is resident on a second host, and
migrating the virtual machine to a first host if the virtual machine is to be migrated, and
coupling the virtual machine to the network, wherein the virtual machine is resident on the first host after migrating.

2. The method of claim 1, wherein migrating the first virtual machine comprises:
determining if the first host comprises resources to support the virtual machine, and
copying the virtual machine from the second host to the first host if the first host comprises resources to support the virtual machine.

3. The method of claim 2, wherein migrating the virtual machine comprises:
coupling the virtual machine migrated to the first host to the network using a virtual connection, wherein the virtual connection is to provide connectivity between the virtual machine and the network, and
detecting presence of a network device coupled to the network using the virtual connection, wherein the network device coupled to the first host is to support a direct connection between the virtual machine and the network.

4. The method of claim 3, wherein migrating comprises hot-plugging the network device to the first host.

5. The method of claim 3, wherein migrating comprises advertising location of the virtual machine after migrating the virtual machine to the first host.

6. The method of claim 3, wherein the virtual machine resident on the first host is to transfer packets to the network using the network device.

7. The method of claim 2, wherein detecting the resources comprises:
estimating resources used by the virtual machine,
sending a first signal to the first host, wherein the first signal is to indicate the estimated resources, and
receiving a second signal from the first host, wherein the second signal is to confirm the availability of the estimated resources on the first host.

8. The method of claim 2, wherein copying the virtual machine comprises:
sending a third signal to the first host, wherein the third signal is to reserve the estimated resources, and
copying data units representing the virtual machine to the first host.

9. A machine readable medium comprising a plurality of instructions that in response to being executed result in a computing device:
determining whether a virtual machine directly coupled to a network is to be migrated, wherein the virtual machine is resident on a second host, and
migrating the virtual machine to a first host if the virtual machine is to be migrated, and
coupling the virtual machine to the network, wherein the virtual machine is resident on the first host after migrating.

10. The machine readable medium of claim 9, wherein migrating the first virtual machine comprises:
determining if the first host comprises resources to support the virtual machine, and
copying the virtual machine from the second host to the first host if the first host comprises resources to support the virtual machine.

11. The machine readable medium of claim 10, wherein migrating the virtual machine comprises:
coupling the virtual machine migrated to the first host to the network using a virtual connection, wherein the virtual connection is to provide connectivity between the virtual machine and the network, and
detecting presence of a network device coupled to the network using the virtual connection, wherein the network device coupled to the first host is to support a direct connection between the virtual machine and the network.

12. The machine readable medium of claim 11, wherein migrating comprises advertising location of the virtual machine after migrating the virtual machine to the first host.

13. The machine readable medium of claim 11, wherein the virtual machine resident on the first host is to transfer packets to the network using the network device.

14. The machine readable medium of claim 10, wherein detecting the resources comprises:
estimating resources used by the virtual machine,
sending a first signal to the first host, wherein the first signal is to indicate the estimated resources, and
receiving a second signal from the first host, wherein the second signal is to confirm the availability of the estimated resources on the first host.

15. The machine readable medium of claim 10, wherein copying the virtual machine comprises:
sending a third signal to the first host, wherein the third signal is to reserve the estimated resources, and
copying data units representing the virtual machine to the first host.

16. A system comprising:
a first virtual machine monitor is to determine whether a virtual machine directly coupled to a network is to be migrated, wherein the virtual machine is resident on a second host,
a second virtual machine monitor resident on a first host and coupled to the first virtual machine monitor, wherein the second and the first virtual machine monitor is to migrate the virtual machine to a first host if the virtual machine is to be migrated, and
the second virtual machine monitor is to couple the virtual machine to the network, wherein the virtual machine is resident on the first host after migrating.

17. The system of claim 16, wherein the first virtual machine monitor is to determine if the first host comprises resources to support the virtual machine, and copy the virtual machine from the second host to the first host if the first host comprises resources to support the virtual machine.

18. The system of claim 17, wherein the second virtual machine monitor is to:
couple the virtual machine migrated to the first host to the network using a virtual connection, wherein the virtual connection is to provide connectivity between the virtual machine and the network, and
detect presence of a network device coupled to the network using the virtual connection, wherein the network device coupled to the first host is to support a direct connection between the virtual machine and the network.

19. The system of claim 18, wherein the second virtual machine monitor is to advertise location of the virtual machine after migrating the virtual machine to the first host.

20. The system of claim 18, wherein the virtual machine resident on the first host is to transfer packets to the network using the network device.
